(19) United States
(12) Patent Application Publication
(10) Pub. No.: US 2025/0065394 A1
(43) Pub. Date: Feb. 27, 2025

(54) CENTER PIN FOR A SECONDARY CELL HAVING AN ENGAGEMENT PROFILE

(71) Applicant: NORTHVOLT AB, Stockholm (SE)

(72) Inventor: Michael KOMA, Stockholm (SE)

(21) Appl. No.: 18/724,057

(22) PCT Filed: Jan. 25, 2023
(86) PCT No.: PCT/EP2023/051751

§ 371 Date: Jun. 25, 2024

(30) Foreign Application Priority Data
Jan. 28, 2022 (SE) 2250078-9

(51) Int. Cl. B21F 3/02; H01M 10/04

(52) U.S. Cl. CPC B21F 3/02; H01M 10/0431

(57) ABSTRACT

There is disclosed herein a center pin (10) for a secondary cell, the center pin (10) comprising a length extending along an axis from a first end to a second end. The center pin comprises a first engagement portion arranged at the first end, wherein an inner surface (20) of the first engagement portion comprises an engagement profile (22) configured to engage with a torque-applying tool to thereby enable the center pin (10) to be rotated about the axis by the torque-applying tool.

### TECHNICAL FIELD

The present disclosure generally relates to secondary cells and components thereof. More particularly, the present disclosure relates to an adapted center pin for a secondary cell, a secondary cell comprising an adapted center pin and a method for manufacturing a secondary cell with an adapted pin.

### BACKGROUND

In addressing climate change there is an increasing demand for rechargeable batteries, e.g. to enable electrification of transportation and to supplement renewable energy. Currently, lithium-ion batteries are becoming increasingly popular, representing a type of rechargeable battery in which lithium ions move from the negative electrode to the positive electrode during discharge and back when charging.

As the demand for rechargeable batteries increases, more and more focus is being placed on production speed. To achieve an effective production of rechargeable batteries, the design of the batteries as well as their manufacturing process can be optimized.

### SUMMARY

It is an object of the disclosure to propose an adapted center pin for a secondary cell, wherein the adapted center pin comprises an engagement profile for engaging with a torque-applying tool to thereby enable the center pin to be rotated about the axis by the torque-applying tool. It is also an object of the disclosure to propose a method of manufacturing a secondary cell comprising, and using, such an adapted center pin.

According to an aspect, there is provided a center pin for a secondary cell. The center pin comprises a length extending along an axis from a first end to a second end, such that the center pin may form a substantially tubular, prismatic or other elongated shape.

The center pin further comprises a first engagement portion arranged at the first end, wherein an inner surface of the first engagement portion comprises an engagement profile configured to engage with a torque-applying tool to thereby enable the center pin to be rotated about the axis by the torque-applying tool.

According to a further aspect, there is provided a secondary cell comprising the center pin as previously described, and an electrode assembly comprising a series of sheets wound around the center pin.

According to yet a further aspect, there is provided a method of manufacturing the aforementioned secondary cell. The method comprises attaching an edge of the electrode assembly to the center pin, engaging the first engagement portion and the torque-applying tool, and rotating the center pin about the axis using the torque-applying tool to thereby wind the electrode assembly around the center pin.

Thus, it is seen that aspects of the present disclosure are unified at least by their comprising an engagement profile formed on an inner surface of an engagement portion of the center pin. The engagement profile enables the center pin to be wound by a torque-applying tool, which may have a complementary shape to at least the engagement profile if not the entire inner surface of the first engagement portion.

Therefore, larger wound electrode assemblies (which may also be referred to herein as electrode roll assemblies or ‘jelly rolls’) can be formed, as more torque can be easily applied to the center pin without otherwise risking damage to the center pin. That is, torque can be more reliably applied through the first engagement portion, which is integral to the structure of the center pin itself, and this allows for an increased weight to be loaded onto the center pin. Thus, larger capacity secondary cells may advantageously be formed more quickly, allowing for greater throughput when manufacturing secondary cells.

In some examples, at least a portion of an outer surface of the center pin may have an outer surface profile corresponding to a shape of a casing of the secondary cell. Therefore, the jelly roll, when formed by rotating around such a center pin, may have a shape substantially conforming to the outer surface profile, thus allowing for a good fit within the casing of the secondary cell.

A further advantage of having a center pin such as that described herein is that the core size of a cell can be maximized. In other words, the opening in the middle of a jelly roll can be made to a specific size and it can be kept that size by the center pin. Hence, stress in the electrode assembly, which may come from swelling etc. during charging/discharging of the cell, can be concentrated in the inner layers of the wound electrode assembly. Considering scale factor and the swelling of electrode assembly layers, a larger diameter of the opening in the middle of the jelly roll may improve cycle (charge/discharge) performance.

Another advantage with a large diameter opening in the middle of the jelly roll is that it allows for a better gas conduit (e.g. for gases created during cell failure) which may provide better safety.

If, according to a comparative example, the center pin were added after winding the jelly roll, the diameter of the center pin may need to be made smaller to be able to insert it into the opening. This may, in turn also lead to a smaller opening in the jelly roll when it adapts to the shape of the center pin.

The secondary cell may be a cylindrical secondary cell, i.e. a secondary cell with a cylindrical casing. In such a case, the outer surface of the center pin may have a circular outer surface profile. In other examples, the casing (and consequently the outer surface profile) may be rectangular, elliptical, or another other suitable shape for a secondary cell.

It is typical to expect the electrode assembly/jelly roll to be formed of a series of sheets having uniform thickness. Thus, the winding of the electrode assembly around the center pin may result in a shape that is defined by the shape of the outer surface of the center pin. However, in some examples, if the electrode assembly has a non-uniform thickness, this may be accounted for in the configuration of the outer surface profile.

When rotating the center pin to wind an electrode assembly therearound, the second end of the center pin may be braced against a flat or shaped surface to provide a reactionary force against the torque-applying tool and thus enable reliable engagement thereof with the first engagement portion at the first end. For example, the second end may be configured to be rotatably mounted or braced so as to reduce torsional strain along the length of the center pin (i.e. where the first end of the center pin may over- or under-rotate relative to the second end).

In some examples, the center pin may further comprise a second engagement portion arranged at the second end. As with the first engagement portion, an inner surface of the second engagement portion may comprise a second engagement profile configured to engage with a torque-applying tool to thereby further enable the center pin to be rotated about the axis by the torque-applying tool.

By providing two engagement portions, with one at each end, the torque can be applied at both ends, thereby reducing potential strain/sheering along the length of the center pin, which could damage the center pin during manufacturing of a secondary cell therefrom, thus reducing an overall throughput of secondary cell manufacture.

The torque applying tool engaging with the second engagement profile may advantageously be the same tool as that engaging with the first engagement profile, such that the rotations of both ends may be easily matched.

The second engagement profile may be similar or the same as the first engagement profile in respect of its shape, or it may be different. For example, if it is desired that the electrode assembly be wound in a particular direction relative to the orientation of the center pin, the required orientation may be enforced by matching of the engagement profiles with respective torque-applying tools.

Alternatively, it may further enhance throughput of manufacture of secondary cells to configure the first and second engagement profiles with a same shape, such that either orientation of the center pin is compatible for engagement with the torque-applying tool(s) (e.g. in a semi-automated assembly-line manufacturing process).

In some examples, the inner surface of the center pin may have the same profile along the length of the center pin. Therefore, deformation of the center pin or torsional strain along the jelly roll is even along its length, thus preventing the development of potential weak spots at the transitions between engagement portions and other portions of the center pin.

Furthermore, if the center pin has a uniform cross-sectional profile along its length, it may simplify manufacture of the center pin, e.g. by rolling sheet metal, axial etching through a plastic blank using a laser (i.e. substrative laser manufacturing), or the like.

The geometry of the engagement profile may take any suitable form, which may be determined at least in part by the magnitude of torque expected to be applied to the center pin. It will be appreciated that an engagement profile may only constitute a portion of the inner surface of the engagement portion(s), such that not all of the inner surface contacts the torque-applying tool when the tool is engaged with the engagement profile.

In some examples, the engagement profile (i.e. on the inner surface of the first or second engagement portion) may have a polygonal geometry, which may thus allow for ease of manufacture, e.g. using rolled sheet metal or the like.

According to some further refinements, the polygonal geometry may be a regular polygon, i.e. a polygon having equal sides. Regular polygons have rotational symmetry; thus, such a geometry of the engagement profile may allow the torque-applying tool to be engaged at one of several rotational positions, thus simplifying engagement between the torque-applying tool and the engagement portion.

Furthermore, a regular polygonal geometry for the engagement profile will result in evenly distributed thinner portions in the thickness of the center pin, which can be thought of as compression zones. Therefore, a regular polygonal geometry may enable an even deformation under expansion/contraction of the jelly roll (which may occur during charging or discharging of the secondary cell).

When winding/rolling the electrode assembly around the center pin, the electrode assembly may be attached to the center pin in any suitable way, such as taping or gluing the edge of the electrode assembly along the length axis of the center pin such that rotation of the center pin encourages winding of the electrode assembly around the center pin.

Additionally or alternatively, the center pin may further comprise a recess on an outer surface of the center pin, extending along the length, configured to receive an edge of an electrode assembly.

Providing a recess may allow for the electrode assembly to be simply attached to the center pin without creating a bump or perturbance in the shape of the formed jelly roll, which would otherwise risk a poor fit of the jelly roll/electrode assembly inside the casing of the secondary cell.

In some examples, the recess may have a rounded profile. By rounding the profile of the recess, risk of damage to the electrode assembly can be reduced, e.g. during rotation/winding of the jelly roll around the center pin, or during deformation thereof.

The recess may extend through any portion of the thickness of the center pin, depending on an amount of attachment or engagement desired for the electrode assembly in the recess. The recess may extend through a thickness (i.e. the entire thickness) of the center pin, thereby forming an open seam extending along the length of the center pin.

Thus, the edge of the electrode assembly can be reliably introduced to the recess of the center pin, and the edges of the open seam can ‘pinch’ the electrode assembly to hold it in place, e.g. as a result of radial pressure introduced by the winding process.

The open seam may also aid in the deformation of the center pin. That is, the swelling/expansion of the electrode assembly can be accommodated for without impinging upon the casing by allowing the center pin to deform an amount corresponding to the expected swelling/expansion.

Additionally or alternatively, the thickness of the center pin may be provided with compression zones configured to enable deformation of the center pin under radial pressure.

The compressions zones may comprise thinner portions of the center pin or waffle, grid-like, foamed, or otherwise formed lower-density portions of the center pin which aim to guide deformation thereof, thus preventing damage to the center pin and/or cell during expansion and contraction of the jelly roll.

The compression zones may be formed through any suitable manufacturing means such as subtractive or additive manufacturing, depending for example on the manufacturing technique used for manufacturing the center pin itself.

The manufacturing of the secondary cell may comprise welding processes, such as those carried out using laser welding. Such welding processes may be required on another side of the center pin relative to the welding laser. However, these welding processes may be desired to be carried out after installation of the center pin (e.g. having the electrode assembly wound therearound).

Therefore, according to some examples, the shape of the center pin may define an axial aperture configured to permit passage of a laser along the length of the center pin. It will be appreciated that these axial apertures may be comprised as part of a same engagement profile extending along the length axis of the center pin.

For example, the center pin may comprise a prismatic internal geometry such that the engagement profile comprises a regular polygonal geometry. In such an example, the thinner portions of the center pin may be evenly radially distributed, thus providing even deformation zones. Furthermore, the engagement profile extending along the length may provide an appropriate axial aperture for permitting passage of a laser for carrying out welding processes.

### BRIEF DESCRIPTION OF DRAWINGS

The above and other aspects of the present invention will now be described in more detail, with reference to the appended figures.

FIG. 1 shows an exploded view of internal components of a secondary cell.

FIGS. 2A and 2B schematically show a center pin having an engagement portion with an engagement profile on its inner surface, according to embodiments.

FIGS. 3A-C schematically show alternative configurations for engagement portions in a center pin, according to embodiments.

FIGS. 4A and 4B schematically show a winding of an electrode assembly around a center pin, according to embodiments.

FIG. 5 schematically shows a method of manufacturing a secondary cell, according to embodiments.

FIGS. 6A-C schematically show alternative configurations for an engagement profile in a center pin, according to embodiments.

FIGS. 7A and 7B schematically show a center pin having a recess on its outer surface, according to embodiments.

FIGS. 8A and 8B show alternative configurations for a recess on an outer surface of a center pin, according to embodiments.

FIG. 9 schematically shows a center pin having axial apertures configured to permit passage of a laser, according to embodiments.

FIG. 10 schematically shows a center pin having compression zones, according to embodiments.

### DETAILED DESCRIPTION

The present invention will now be described hereinafter with reference to the accompanying drawings, in which currently preferred, exemplary embodiments of the invention are illustrated. The invention may, however, be embodied in many different forms and should not be construed as limited to the embodiments set forth herein; rather, these embodiments are provided by way of example so that this disclosure will be thorough and complete, and will fully convey the scope of the invention to those persons skilled in the art.

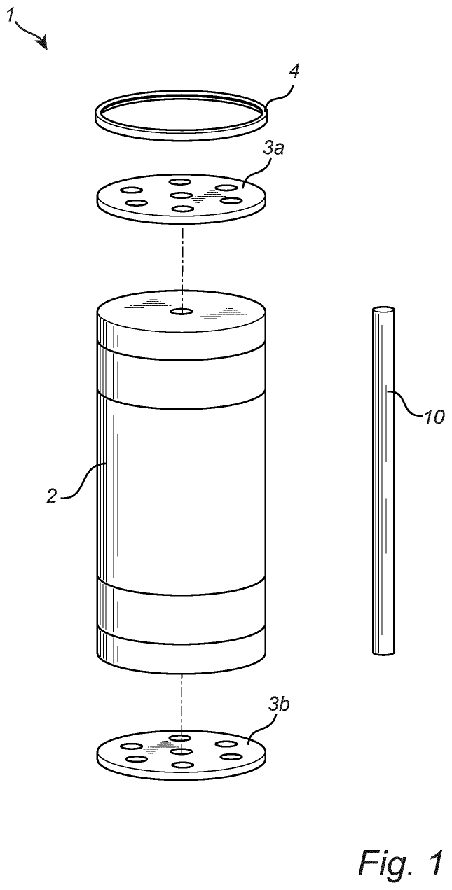

FIG. 1 shows an exploded view of internal components of a secondary cell 1, also referred to as a cell 1. Not shown are the casing of the cell 1, the terminals of the cell 1, or any other external components of the cell 1.

The main internal component of the cell 1 is the electrode assembly 2, which may also be referred to as the electrode roll assembly or the ‘jelly roll’ (because the rolled electrode assembly in a cylindrical form resembles a jelly roll). The electrode assembly 2 is shown as being cylindrical in this illustrated example, although it will be appreciated that the electrode assembly may instead be elliptical, rectangular, or another shape.

The electrode assembly 2 is formed from rolling a series of layers/sheets, comprising conductive sheets and non-conductive spacing sheets. For example, a first conductive sheet may be laid down with a non-conductive spacing sheet laid thereon (e.g. a dielectric), and then a second conductive sheet may be laid thereover, followed by a further spacing sheet, so as to form the electrode assembly, being capable of storing electrical energy as a secondary cell 1.

The bands surrounding the electrode assembly 2 may be straps or tape arranged to maintain the electrode assembly 2 in its rolled form such that it may be easily installed into a casing, e.g. a cylindrical casing similar in shape to the rolled electrode assembly (not shown).

The cell 1 may further comprise a first current collecting plate 3a and a second current collecting plate 3b for collecting current from the first and second conductive sheets, respectively, collecting current therefrom and distributing current thereto during charging and discharging of the cell 1. The detailed form of these current collecting plates is not discussed herein.

The cell 1 may further comprise a seal 4 which may be a tape or similar construction for providing a seal and/or spacing between the internal components of the cell 1 and external components of the cell 1. For example, the seal 4 may prevent electrical contact between the first current collecting plate 3a and the casing.

To provide rigidity and structure to the cell 1, a center pin 10 is provided to be placed in the center of the electrode assembly 2. In some comparative examples, the rolling of the electrode assembly 2 may be a separate process to the introduction of the center 10. However, according to the present disclosure, the electrode assembly 2 is rolled around the center pin 10 during a manufacturing process for the cell 1.

That is, an edge of the unrolled electrode assembly 2 may be attached along a length of the center pin 10, which may then be rotated so as to wind the electrode assembly 2 therearound to form a wound shape such as that shown in FIG. 1.

As the electrode assembly 2 is the part of the cell that stores electrical energy, it will be appreciated that a larger or more tightly wound (thus more densely packed) electrode assembly 2 in a cell 1 would enable a greater amount of electrical energy to be stored in the cell 1.

However, winding larger (and thus heavier) electrode assemblies 2 around the center pin 10, or winding electrode assemblies 2 more tightly around the center pin 10 may require a greater amount of torque to be applied to the center pin 10 during the winding process.

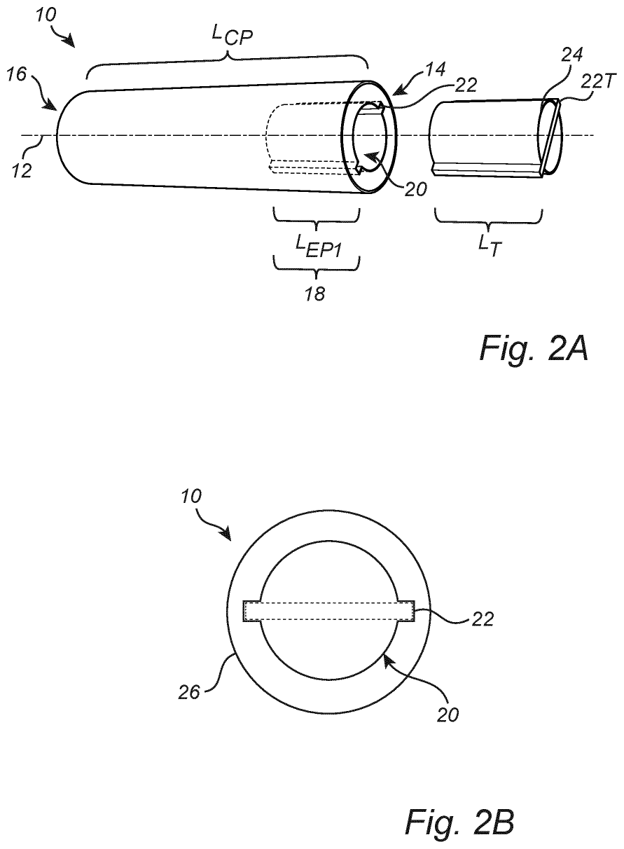

Therefore, as shown in FIGS. 2A and 2B, the present disclosure provides an adapted center pin 10 for enabling a greater amount of torque to be applied to the center pin 10 during a winding process when forming a cell 1 by winding an electrode assembly 2 around a center pin 10.

In FIG. 2A, there is illustrated a center pin 10 similar to that shown in FIG. 1. The center pin 10 has a length L_{CP} extending along an axis 12 from a first end 14 to a second end 16. The external geometry of the center pin 10 is substantially tubular, although this is only an example for the purposes of illustration. It will be appreciated that the external geometry of the center pin 10 may also be frustoconical, prismatic, prismoidal, or the like, which may depend on a desired shape for a jelly roll that is to be formed by winding around the center pin 10.

As illustrated, there is a first engagement portion 18 at the first end 14 of the center pin, which extends a length L_{EP1} from the first end 14. The center pin 10 may otherwise be solid or have hollow portions, depending on structural, economical, or other considerations.

The inner surface 20 of the first engagement portion 18 comprises an engagement profile 22, which in the presently illustrated example comprises two opposing notches extending outwards from an otherwise circular profile. The engagement profile 22 is configured to engage with a torque-applying tool (not shown) to thereby enable the center pin 10 to be rotated about the axis by the torque-applying tool. Only the engaging bit 24 of the tool is shown, and it can be seen that the bit 24 comprises a complementary profile 22T for engaging the engagement profile 22.

In the illustrated example, the bit 24 fully corresponds to the inner surface 20 of the first engagement portion 18 and has a corresponding length L_{T} to the depth L_{EP1} of the first engagement portion 18. However, it will be appreciated that the bit 24 may only engage with the engagement profile 22 of the inner surface 20 of the first engagement portion 18, e.g. having a length L_{T} less than the depth L_{EP1} of the first engagement portion 18.

For example, the bit 24 may have a rectangular shape having a height corresponding to the notches of the engagement profile 18 and a width corresponding to a diameter of the inner surface 20 at the position of the notches, as indicated by the dotted line in FIG. 2B.

The outer surface profile 26 of the center pin may be configured to conform with an expected shape of a casing of the cell. For example, as shown in FIG. 2B, the outer surface profile 26 may be circular if the casing of the cell is expected to be, e.g., cylindrical.

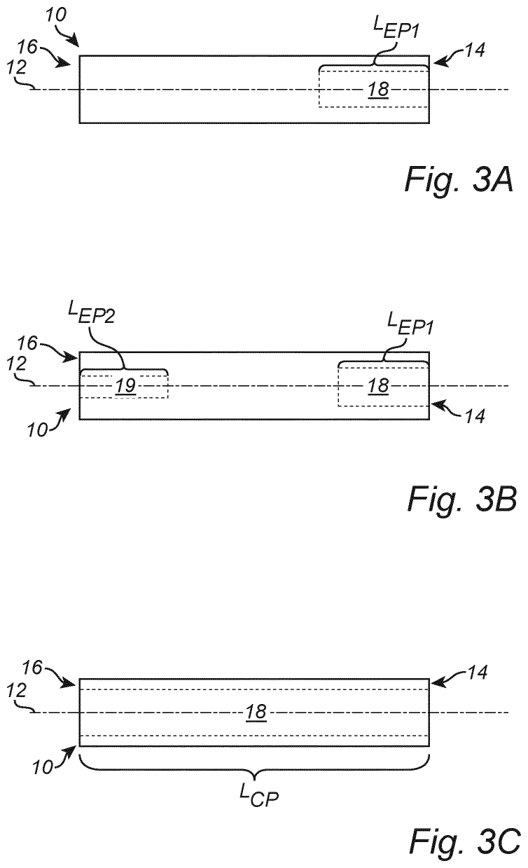

FIGS. 3A-C schematically show alternative configurations for engagement portions in a center pin, according to embodiments. The center pins 10 are shown in a side view, with cross-sectional views of the engagement portion(s) 18 (19).

FIG. 3A may substantially correspond to the illustrated example of FIG. 2A, wherein the first engagement portion 18 extends a length L_{EP1} from the first end 14 of the center pin 10.

FIG. 3B shows an alternative configuration wherein the center pin 10 may further comprise a second engagement portion 19, the inner surface of which may comprise a second engagement profile (not shown) for engaging with the same tool or a different tool than that for engaging with the first engagement portion 18.

The second engagement portion 19 may have a same length L_{EP2} as that of the first engagement portion L_{EP1}, or these lengths may be different. Indeed, respective engagement profiles comprised in the inner surfaces of the different engagement portions 18-19 may be the same or different, depending on the implementation.

FIG. 3C shows a further alternative configuration of an engagement portion 18, wherein the engagement portion 18 extends throughout the length L_{CP} of the center pin 10. In such an example, the inner surface of the center pin may have the same profile along the length L_{CP} of the center pin 10. Alternatively, the inner surface of the center pin may vary along its length, for example transitioning from a first engagement profile at the first end 14, to a second engagement profile at the second end 16, with or without a portion therein between having no engagement profile (e.g. a smooth non-engaging surface).

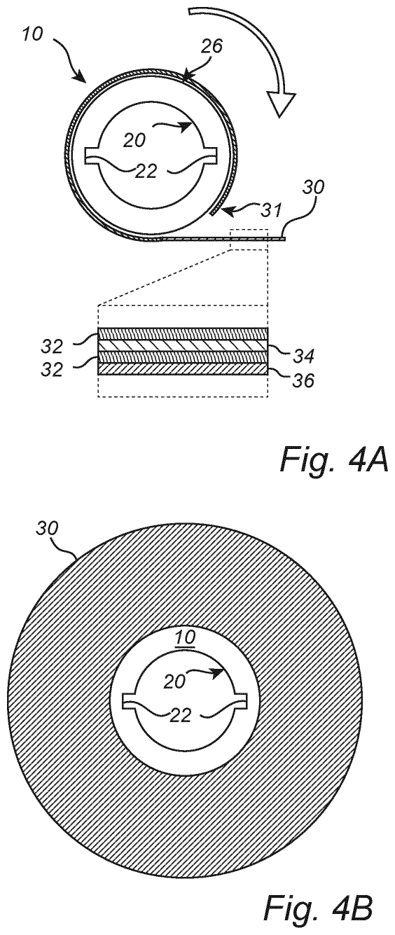

FIGS. 4A and 4B schematically show a winding of an electrode assembly around a center pin, according to embodiments.

As mentioned above, the center pin 10, showing the same example engagement profile 22 on the inner surface 20 of the center pin 10 as that shown in FIGS. 2A and 2B, an edge 31 of an electrode assembly 30 may be attached to the center pin 10 and wound therearound (as indicated by the arrow).

As illustrated in FIG. 4B, the winding process may result in a shape of a jelly roll/electrode assembly 30 that substantially corresponds to an outer surface profile 26 of the center pin 10 (e.g. circular in this example).

FIG. 4A further shows a magnified portion of the electrode assembly 30, showing the series of sheets 32, 34, 36 comprised in the electrode assembly 30. In the illustrated example, the electrode assembly 30 is formed of a first conductive sheet 36, a non-conductive spacing sheet 32 (e.g. a dielectric), a second conductive sheet 34, and a further spacing sheet 32. The first conductive sheet 36 may be an anode material and the second conductive sheet 34 may be a cathode sheet, or vice versa, according to some examples. Such an arrangement may enable the electrode assembly 30 to store electrical energy.

The rate of rotation of the center pin 10 and/or the tension applied to the electrode assembly 30 during winding may be varied and optimized according to the tensile strength of the electrode assembly 30, a desired rate of manufacture and/or further relevant considerations.

The means for attaching the edge 31 of the electrode assembly 30 may comprise an adhesive such as tape or glue, a mechanical fastening such as a clip, a spiked surface to catch the edge 31, and/or any other appropriate means depending on the implementation.

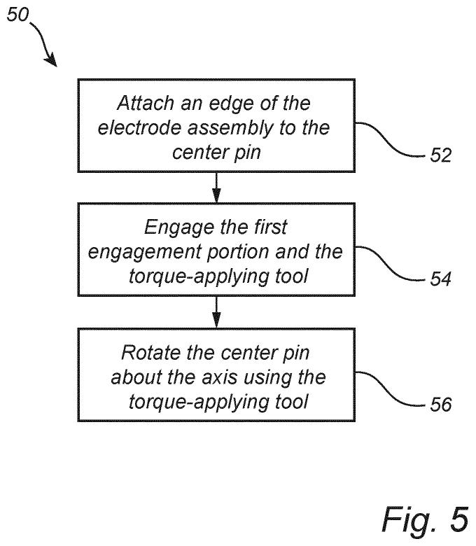

A method 50 for manufacturing a secondary cell according to the present disclosure is schematically shown in FIG. 5.

As shown in FIG. 5, the method 50 comprises attaching 52 an edge of the electrode assembly (e.g. the edge 31 of the electrode assembly 30 shown in FIG. 4A) to the center pin, and engaging 54 the first engagement portion and the torque-applying tool.

Once engaged 54, the method 50 further comprises rotating 56 the center pin about the axis thereof using the torque-applying tool, e.g. as shown in FIG. 4A.

As the center pin comprises an engagement profile, the engagement between the center pin and the torque-applying tool can be made more reliable and thus enable the torque-applying tool to apply greater torque to the center pin than would be possible without the engagement profile.

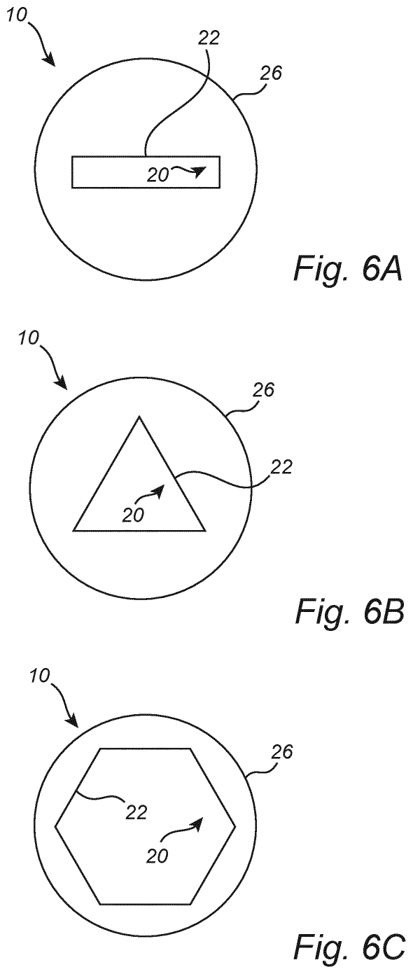

FIGS. 6A-C schematically show further example configurations of engagement profiles for a center pin, where the outer surface profile 26 in these examples is circular. As shown in these figures, the inner surface 20 of the center pin 10 is essentially decoupled from the outer surface profile 26, such that each surface profile 20, 26 can be independently optimized.

Each of FIGS. 6A-C show examples of a polygonal geometry for the engagement profile 22. In each of these examples, it may be assumed that a bit of a torque-applying tool could have a profile corresponding to the entire inner surface 20 of the center pin 10 such that the entire inner surface 20 forms part of the engagement profile 22.

FIG. 6A shows an example of an irregular polygonal geometry (i.e. an oblong rectangle), whilst FIGS. 6B and 6C show examples of a regular polygonal geometry (i.e., an equilateral triangle and a regular hexagon, respectively). As can be appreciated from these figures, the thickness of the center pin 10 may vary radially, resulting in thinner and thicker portions.

The rotational symmetry of the illustrated polygonal geometries may allow for an ease of engagement of a torque-applying tool with the engagement profiles 22, as the tool may be insertable in multiple orientations.

As previously mentioned, the charging and/or discharging of the cell, or thermal changes, may result in expansions or contractions of the electrode assembly. The casing of a cell typically fully encloses the internal components; thus, any expansion of the internal components may need to be accounted for in the design thereof.

In some examples, the center pin 10 may be designed so as to compress under application of inward radial pressure (e.g. a crushing pressure) and/or expand when this inward radial pressure is removed. In such examples, the center pin 10 may be manufactures from a resilient material.

In the illustrated examples of FIGS. 6B and 6C, it can be seen that the thinner and thicker portions are evenly radially distributed about the axis center pin 10. Such geometries may advantageously allow for an even, controlled (i.e. damage-free) compression of the center pin 10 during deformation of an electrode assembly wound therearound. Furthermore, such geometries may provide resilience to the center pin 10 so as to encourage a return to its original shape when the deformation of the electrode assembly is reversed.

Polygonal geometries such as those shown in FIGS. 6A-C may allow for an ease of manufacturing the center pin 10. For example, the center pin 10 shown in 6A may readily be manufactured using subtractive manufacturing techniques, starting from a solid cylinder and using a laser to etch through the length (or a portion thereof) to form the engagement profile in an engagement portion of the center pin 10.

The center pin 10 shown in FIG. 6B may be manufactured from a rolled sheet metal to form the internal geometry, which then may have the remaining body of the center pin molded/casted around said metal internal portion, e.g. from resin plastic or foam. Such a combination may advantageously allow for only the engagement profile 22 to be formed of a hard/strong material, whilst the remainder is formed from a relatively low-weight material. Hence, it can be ensured that the application of torque by a torque-applying tool does not damage the center pin 10 when it is engaged with the engagement profile 22, whilst the overall weight of the center pin 10 can be kept down.

As a further example, the center pin 10 shown in FIG. 6C may be additively manufactured (AM), e.g. using 3D-printing or similar techniques, from metal or plastic, depending on the implementation and the desired strength for the center pin 10. Straight lines may typically increase the ease with which AM techniques can be applied, thus polygonal geometry such as the hexagonal engagement profile shown in FIG. 6C may advantageously increase the speed and ease with which the center pin 10 can be manufactured.

It will be appreciated that the foregoing examples for manufacture of the center pins 10 are not intended to be particular associated with any particular engagement profile 22, and these techniques or others may be applied to any inner surface 20 as deemed appropriate for desired characteries of a center pin 10, e.g. in respect of strength (tensile or compressive), compressibility, weight, etc.

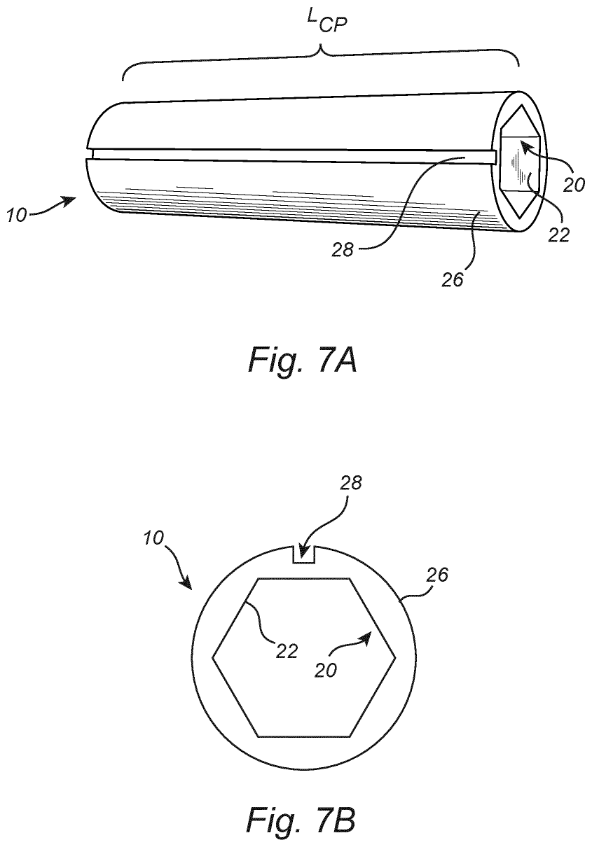

Turning now to FIGS. 7A and 7B, these figures show a center pin 10 having a recess 28 on its outer surface 26, according to embodiments. For illustrative purposes only, the hexagonal engagement profile 22 from FIG. 6C has been included in FIGS. 7A and 7B.

Instead of attaching the electrode assembly by additional fixing means, the provision of a recess 28 may advantageously provide a simple yet reliable means for attaching the electrode assembly to the center pin 10. Furthermore, the recess 28 may mitigate or eliminate any bump or deviation from an intended shape of a jelly roll (rolled electrode assembly) as a result of subsequent layers of the electrode assembly being wound over the starting edge thereof.

As shown in FIG. 7A, the recess 28 may extent along a length L_{CP} of the center pin 10. In this illustrated example, the recess 28 is straight, i.e. having a consistent position in a radial direction on the outer surface 26 of the center pin 10. However, in some examples, the recess 28 may wind or curve along the length L_{CP} of the outer surface 26. In some examples, the recess may not necessarily extend along the entire length L_{CP} of the center pin, depending on the form of the electrode assembly and how it is intended to wind the electrode assembly around the center pin 10, for example.

A top view of the center pin 10 shown in FIG. 7A is shown in FIG. 7B. Although only one recess 28 is shown, further recesses may be added, which may, for example, advantageously reduce the weight of the center pin 10 without substantially affecting the resultant shape of the jelly roll.

When attaching an electrode assembly to the center pin 10, an edge thereof (e.g. edge 31 shown in FIG. 4A) may be introduced into the recess 28 so as to catch or otherwise leverage the electrode assembly during rotation of the center pin 10, thereby encouraging a winding of the electrode assembly around the center pin 10.

Thus, the recess 28 may be shaped and sized in accordance with an expected thickness of the electrode assembly, and may be deep enough to encourage such an attachment/catching between the center pin 10 and the electrode assembly during rotation of the center pin 10.

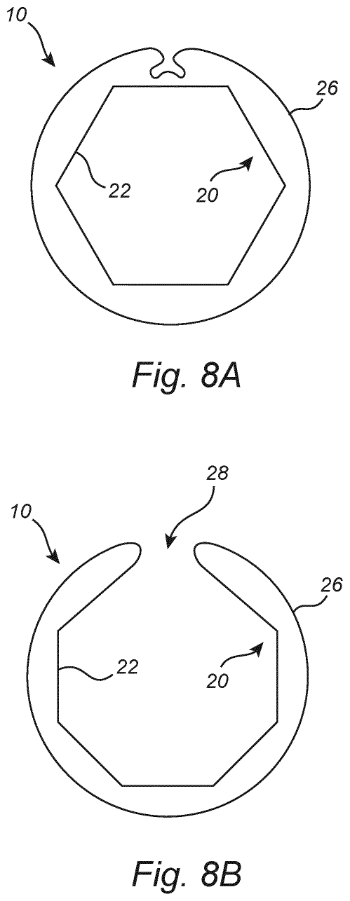

FIGS. 8A and 8B show alternative configurations for a recess 28 on an outer surface 26 of a center pin 10, according to embodiments.

As shown in FIG. 8A, the recess 28 may have a rounded profile, and may be configured to bias the electrode assembly against a direction of rotation, so as to ensure a good engagement between the electrode assembly and the center pin 10 even when greater torque or speeds of rotation are applied. By rounding the profile, damage to the electrode assembly may be mitigated or prevented, as the electrode assembly may not be pressed against sharp corners during winding. By preventing damage or detachment of the electrode assembly from the center pin 10 during winding, a throughout of manufacturing of secondary cells may be advantageously increased.

FIG. 8B shows a further optional refinement of a configuration of a recess 28. As shown in FIG. 8B, the recess may extend through a thickness of the center pin 10, thereby forming an open seam extending along the length of the center pin 10.

Such an open seam recess 18 may have multiple advantages. For example, when an electrode assembly is introduced into the open seam recess 28 and then wound around the center pin 10, the open seam 28 may be biased closed, thereby pinching or squeezing the electrode assembly and preventing displacement thereof from the open seam recess 28. In such examples, the profile of the ‘jaws’ of the open seam 28 may be rounded so as to prevent or mitigate damage to the electrode assembly.

Furthermore, the open seam 28 may allow for a resilient expansion or contraction of the center pin 10, thus enabling the center pin 10 to accommodate for expansions or contractions of a jelly roll formed therearound, as discussed above. The size of the open seam 28 may be configured in accordance with an expected expansion or contraction of the jelly roll/electrode assembly.

As will be appreciated from FIG. 8B, the open seam 28 may not substantially interfere with the function of the engagement profile 28, as only a relatively small portion of the inner surface 20 of the center pin (i.e. the first engagement portion thereof) is interrupted by the provision of the open seam 28.

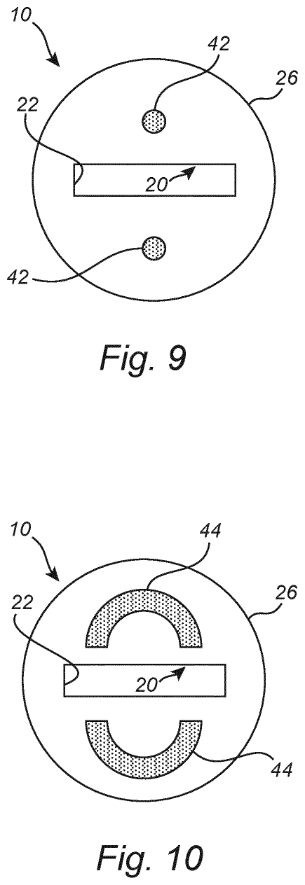

FIGS. 9 and 10 illustrate further optional refinements of a center pin 10, according to embodiments.

FIG. 9 schematically shows a center pin 10 having axial apertures 42 configured to permit passage of a laser, according to embodiments.

Turning to FIG. 1 for illustration, the manufacture of the cell 1 may take place using machinery or process that are applied from a same side, e.g. from above as shown in FIG. 1. Thus, if the second current collecting plate 3b were desired to be welded to metal tabs on the electrode assembly 2, or to a terminal of a casing (not shown) the welding would need to take place with the other internal components (e.g. center pin 10 and electrode assembly 2) in the path of the welding process, which may involve laser welding.

Thus, axial apertures 42 such as those shown in FIG. 9 may be manufactured as part of the center pin 10 (e.g. by etching or AM techniques) in positions corresponding to desired laser welding locations on the other side of the center pin 10. There may be as many axial apertures 42 formed as desired welding locations, in some examples.

By providing these axial apertures 42, the ease and speed of manufacturing a secondary cell may be further improved. It will be appreciated that, if the center pin 10 is entirely hollow along its length with a suitably shaped inner surface 20 to permit passage of a laser towards desired welding locations, these axial apertures 42 may not be required.

FIG. 10 schematically shows a center pin 10 having compression zones 44, according to embodiments. The compression zones 44 may be formed during manufacture of the center pin 10, e.g. using AM techniques, or may be introduced after the center pin 10 has been manufactured, e.g. using etching or other subtractive manufacturing (SM) techniques.

The compression zones 44 may allow for configurable or predetermined deformation of the center pin 10, e.g. during expansion or contraction of an electrode assembly wound therearound. In some examples, the anticipated stress on a center pin 10 during use of a cell may be modelled/simulated and based thereon, suitable compression zones 44 may be determined for including in the center pin 10.

With the advance of manufacturing techniques such as 3D printing, such compression zones 44 may take any, even complex, form, as desired. It will be appreciated that these compression zones 44 may not be required if the inner surface 20 of the center pin 10 (e.g. including an open seam recess) is capable of accommodating the expected expansions and contractions of the electrode assembly.

Although specific operational examples have been discussed above, it will be appreciated that these examples have been provided for illustrative purposes only, and are not intended to be limiting upon the scope of the present disclosure. Indeed, any combination of the above described examples shall be considered as falling within the scope of the present disclosure. For the avoidance of doubt, it is the intention for the scope of the present invention to be defined by the following claims.

1-13. (canceled)

14. A center pin (10) for a secondary cell, the center pin (10) comprising:
a length extending along an axis from a first end to a second end;
a first engagement portion arranged at the first end,
wherein an inner surface (20) of the first engagement portion comprises an engagement profile (22) with a regular polygonal geometry, configured to engage with a torque-applying tool to thereby enable the center pin (10) to be rotated about the axis by the torque-applying tool; and
a recess (28) on an outer surface (26) of the center pin (10), extending along the length, configured to receive an edge of an electrode assembly,
wherein the recess (28) extends through a thickness of the center pin (10), thereby forming an open seam extending along the length of the center pin (10).

15. The center pin according to claim 14, wherein at least a portion of an outer surface of the center pin has an outer surface profile corresponding to a shape of a casing of the secondary cell.

16. The center pin according to claim 15, wherein the casing is cylindrical and the outer surface of the center pin has a circular outer surface profile.

17. The center pin according to claim 14, further comprising a second engagement portion arranged at the second end, wherein an inner surface of the second engagement portion comprises a second engagement profile configured to engage with a torque-applying tool to thereby enable the center pin to be rotated about the axis by the torque-applying tool.

18. The center pin according to claim 17, wherein inner surfaces of the first engagement portion and the second engagement portion have the same engagement profile.

19. The center pin according to claim 18, wherein the inner surface of the center pin has the same profile along the length of the center pin.

20. The center pin according to claim 14, wherein the recess has a rounded profile.

21. The center pin according to claim 14, wherein the shape of the center pin defines an axial aperture configured to permit passage of a laser along the length of the center pin.

22. The center pin according to claim 14, wherein the thickness of the center pin is provided with compression zones configured to enable deformation of the center pin under radial pressure.

23. A secondary cell, comprising:
the center pin according to claim 14; and
an electrode assembly comprising a series of sheets wound around the center pin.

24. A method for manufacturing the secondary cell of claim 23, comprising:
attaching (52) an edge of the electrode assembly to the center pin at the recess on the outer surface thereof;
engaging (54) the first engagement portion and the torque-applying tool; and
rotating (56) the center pin about the axis using the torque-applying tool to thereby wind the electrode assembly around the center pin.
